(19) United States
(12) Patent Application Publication
(10) Pub. No.: US 2007/0033939 A1
(43) Pub. Date: Feb. 15, 2007

(54) Turbocharged intercooled engine utilizing the turbo-cool principle and method for operating the same

(76) Inventors: Lin-Shu Wang, Stony Brook, NY (US); Shiyou Yang, Madison, WI (US)

Correspondence Address: DILWORTH & BARRESE, LLP, 333 EARLE OVINGTON BLVD., UNIONDALE, NY, 11553, US

(21) Appl. No.: 11/583,182

(22) Filed: Oct. 19, 2006

Related U.S. Application Data
(63) Continuation-in-part of application No. 11/155,862, filed on Jun. 16, 2005.
(60) Provisional application No. 60/590,100, filed on Jul. 22, 2004.
(60) Provisional application No. 60/580,493, filed on Jun. 17, 2004.
(60) Provisional application No. 60/728,223, filed on Oct. 19, 2005.
(60) Provisional application No. 60/780,729, filed on Mar. 9, 2006.

(51) Int. Cl. F02B 33/44; F02B 29/04

(52) U.S. Cl. 60/612; 60/599

(57) ABSTRACT

A turbocharged-intercooled engine utilizing the turbo-cool principle and method for operating the same. The engine has an air turbine for turbo-expansion cooling. The air turbine is coupled to a compressor so intake air pressure loss as a result of turbo-expansion is partially compensated by pressure gain due to the compression process. This use of an air turbine and its coupling to a compressor define the essence of the turbo-cool principle.

### CROSS REFERENCE TO RELATED APPLICATIONS

This application is a continuation-in-part of an application filed in the United States Patent and Trademark Office (USPTO) on Jun. 17, 2005 and assigned Ser. No. 11/155,862, that claims priority under 35 U.S.C. § 119 to applications filed in the USPTO on Jul. 22, 2004 and assigned Ser. No. 60/590,100, and on Jun. 17, 2004 and assigned Ser. No. 60/580,493, the contents of each of which are incorporated herein by reference. This application also claims priority under 35 U.S.C. § 119 to applications filed in the USPTO on Oct. 19, 2005 and assigned Ser. No. 60/728,223, and on Mar. 9, 2006 and assigned Ser. No. 60/780,729, the contents of each of which are incorporated herein by reference.

### BACKGROUND OF THE INVENTION

1. Field of the Invention

The present invention generally relates to turbocharged internal combustion engines and, more particularly, to a turbocharged-intercooled engine utilizing the turbo-cool principle and method for operating the same. Such a turbocharged-intercooled engine may be a homogeneous charge spark ignition (SI) type, a heterogeneous charge (direct-injection) spark ignition type, a heterogeneous charge compression ignition (diesel) type, or a homogeneous charge compression ignition (HCCI) type. a turbocharged-intercooled engine, which may be a homogeneous charge spark ignition (SI) type, a heterogeneous charge (direct-injection) spark ignition type, a heterogeneous charge compression ignition (diesel) type, or a homogeneous charge compression ignition (HCCI) type.

2. Description of the Related Art

There is a compelling logic in applying turbocharging to internal combustion engines in terms of the resulting mechanical and thermodynamic advantages of the turbocharged internal combustion engine. It is straightforward that high power output would be the result of high intake charge pressure due to turbocharging compression (turbo-compression). The full potential of this turbo-compression, especially for SI engines, is realizable, however, only if a given high intake charge-air pressure, or a given high engine load, is accompanied with a correspondingly desirable (low, usually) intake air temperature. Such a desirable set of intake air pressure (thus, engine load) and intake air temperature can also produce other mechanical and thermodynamic advantages, as well as the advantage in low engine emission.

Applying turbocharging to piston engines in practice poses a technological challenge in the form of matching a turbocharger unit to a piston engine unit, especially for spark-ignition (SI) gasoline engines.

For diesel engines, matching of turbochargers with piston units has been satisfactorily, if not optimally, developed. As a result, turbocharged diesels enjoy a clear and irresistible superiority in power and efficiency over naturally-aspirated (NA) diesels in heavy-duty use (as well as in light-duty application), and are hugely successful in the marketplace.

For SI engines, matching is more difficult due to the possibility of knock in SI engine combustion—its avoidance also necessitates reduction in the compression ratio of the turbocharged gasoline engines creates a negative perception. The misleadingly negative perception is that turbocharged gasoline engines fall short of any efficiency gain. As a result, turbocharged SI engines have enjoyed far less success in the marketplace.

The combination of gas expansion in a piston engine of lower-compression-ratio and gas expansion through a turbocharger turbine does not imply that the turbocharged engine has lower effective expansion ratio (EER) than its NA version of normal compression-ratio. It is EER, which depends on compression ratio and turbocharging compression/expansion pressure ratio, not compression ratio alone, that is the key to engine efficiency and performance. In fact, the EER of current turbocharged gasoline engines is higher than NA gasoline engines.

However, it is true that although turbocharged engines do not suffer from lower EER (and the negative perception is misleading), the current practice of turbocharging technology relying on the operation of bypassing part of engine exhaust through a wastegate fails to realize the full potential in significantly higher EER possible for turbocharged engines. That is, turbocharged gasoline engines fall short of the full potential of possible efficiency gain. A Variable Geometry Turbine (VGT) turbocharger, though developed originally for gasoline engines, has failed to bring about (except the reduction of turbo-lag) any improvement in the performance of turbocharged gasoline engines as expected on theoretical ground.

A critical factor that has been overlooked in considering VGT turbochargers for SI engine application in the past is the back pressure to the piston engine, and consequently, the resulting residual gas and its effect on the temperature of in-cylinder mixture at the beginning of combustion. That is, VGT turbocharger operation affects engine back pressure, which affects the in-cylinder mixture temperature, which affects the tendency for engine knock, which limits engine performance.

Therefore, a need exists for a turbocharged-intercooled engine utilizing the turbo-cool principle and method for operating the same. Such a turbocharged engine includes a turbo-charging system that utilizes exhaust-gas expansion in a turbine to achieve a higher engine EER, and an exhaust-gas turbine that not only powers a compressor to produce turbo-compressed and intercooled air but also leads to the conditioning of turbo-compressed and intercooled air temperature to mitigate engine knock and provide other benefits for engine operation.

### SUMMARY OF THE INVENTION

Accordingly, an object of the present invention is to provide a turbocharged-intercooled engine utilizing the turbo-cool principle and method for operating the same. The engine has an air turbine for turbo-expansion cooling. The air turbine is coupled to a compressor so intake air pressure loss as a result of turbo-expansion is partially compensated by pressure gain due to the compression process. This use of an air turbine and its coupling to a compressor define the essence of the turbo-cool principle.

According to one aspect of the present invention, a turbocharger, turbocharged intercooled engine, turbocharging method, and engine management method are provided. The turbocharger includes an exhaust turbine, a compressor, and an air turbine on a single axle. In the turbocharger, intake air pressure loss as a result of turbo-expansion is partially compensated by pressure gain due to a compression process in the compressor. The exhaust turbine, compressor, or air turbine may be of a variable geometry type of turbine or compressor. The turbocharger may have a supercharger.

The turbocharged intercooled internal combustion engine includes a turbocharging system with an exhaust turbine, a compressor, and an air turbine; a first operation control unit for load and speed control; a second operation control unit for conditioning intake air temperature; and an operation control for controlling start-of combustion, wherein the first operation control unit and the second operation control unit simultaneously control load-and-speed and conditioning of intake air temperature.

The second operation control unit may include a turbo-cooler valve for distributing turbo-compressed and intercooled airflow into a charge-airflow and a coolant airflow, wherein the air turbine is for expanding and cooling the coolant airflow; and a heat transfer unit where the expanded and cooled coolant airflow absorbs heat from the charge-airflow. The air turbine may drive a second compressor on a separate axle from the exhaust turbine axle. The air turbine may drive a suction-compressor on a separate axle from the exhaust turbine axle, and the suction-compressor compresses coolant airflow exiting from the heat transfer unit to ambient pressure and discharges the coolant airflow.

The internal combustion engine may be a homogeneous charge spark ignition engine, wherein the first operation control unit includes a throttle butterfly and geometry control of the exhaust turbine; the start-of-combustion is controlled by a spark plug; and the conditioning of intake air temperature improves thermal efficiency and avoids knock. The internal combustion engine may be a diesel (heterogeneous charge compression ignition) engine, wherein the first operation control unit includes a fuel injection system and a geometry-control of the exhaust turbine; the start-of-combustion is controlled by the fuel injection timing; and the conditioning of intake air temperature improves thermal efficiency and reduces thermal loading at high engine loads. The internal combustion engine may be an HCCI engine, wherein the first operation control unit includes a fuel injection system, a throttle butterfly and a geometry-control of the exhaust turbine; and the start-of-combustion is controlled to promote ignition at low loads, and the second operation control unit prevents premature ignition at high engine loads.

The turbocharging method includes providing a turbocharger including an exhaust turbine, a compressor, and an air turbine; and simultaneously controlling load-and-speed and conditioning of intake air temperature.

The conditioning of intake air temperature step may be performed by a cooling effect of turbo-expansion of turbo-compressed and intercooled air through an air turbine. The exhaust turbine, compressor, and/or air turbine may be a variable geometry type of turbine or compressor. The conditioning of intake air temperature step may be performed by extraction of heat by a coolant airflow from a charge-airflow, the coolant airflow being produced by a cooling effect of turbo-expansion of excess compressed air through the air turbine. The engine may be a homogeneous charge spark ignition internal combustion engine, wherein the controlling of load-and-speed step is performed by a throttle butterfly and geometry-control of the exhaust turbine.

The turbocharging method may include establishing a function for achieving optimal thermal efficiency at a given intake air pressure; and setting a nozzle opening of the exhaust turbine as a function of a throttle butterfly setting, an intake air pressure, an engine speed, an ambient temperature, a pressure, and a humidity. The method may provide the turbocharger in a diesel (heterogeneous charge compression ignition) engine, wherein the controlling of load-and-speed step is performed by fuel-rate control and geometry-control of the exhaust turbine. The method may include establishing a function for achieving optimal thermal efficiency at a given intake air pressure; and setting a nozzle opening of the exhaust turbine as a function of a fuel rate control setting, an intake air pressure, an engine speed, an ambient temperature, a pressure, a humidity. The method may include providing the turbocharger in a direct-injection spark ignition engine, or in an HCCI engine.

The method may include performing geometry control of the air turbine to condition intake air temperature, establishing a function for conditioning intake air temperature at a given intake air pressure to produce start-of-combustion at a crank angle resulting in maximum brake torque; and setting a nozzle opening of the exhaust turbine and a nozzle opening of the air turbine according to the established function. The method may include establishing the function for conditioning intake air temperature according to a fuel rate control setting, a throttle butterfly setting, an intake air pressure, an engine speed, an ambient temperature, a pressure, and a humidity.

The engine management method includes provides a turbocharger including an exhaust turbine, a compressor, and an air turbine; sensing engine management data; and generating outputs based on the sensed data. The sensing engine management data step may include sensing data including a load requirement signal, an intake manifold pressure, an engine speed, a knock sensor signal for a homogeneous charge spark ignition engine, a fuel air ratio, a temperature sensor signal, an ambient condition, and a crank angle at start-of-combustion. The generating outputs step may include generating a signal for a servo element for controlling a nozzle opening of the exhaust turbine, generating a signal for a servo element for controlling a nozzle opening of the air turbine, or generating a signal for a servo element for controlling a geometry-setting of the compressor.

The generating outputs step may include selecting an output for improving thermal efficiency and reducing thermal loadings at high engine loads in application to heterogeneous charge compression ignition engines leading to improved rated power. The generating outputs step may include selecting an output for improving thermal efficiency and producing start-of-combustion at a crank-angle at middle and high engine loads resulting in maximum brake torque in application to homogeneous charge compression ignition engines, selecting an output for conditioning intake air to improve thermal efficiency and avoid knock in application to homogeneous charge spark ignition engines, or selecting an output for improving thermal efficiency and reducing thermal loadings at high engine loads in application to heterogeneous charge compression ignition engines leading to improved rated power, or selecting an output for improving thermal efficiency and producing start-of-combustion at a crank-angle at middle and high engine loads resulting in maximum brake torque in application to homogeneous charge compression ignition engines.

### BRIEF DESCRIBPTION OF THE DRAWINGS

The above and other objects, features and advantages of the present invention will be more apparent from the following detailed description taken in conjunction with the accompanying drawings, in which:

FIG. 1 is a block diagram of a turbocharged intercooled engine according to the present invention;

FIG. 2 is a block diagram of another turbocharged intercooled engine according to the present invention;

FIG. 3 is a block diagram of another turbocharged intercooled engine according to the present invention;

FIG. 4 is a block diagram of another turbocharged intercooled engine according to the present invention;

FIG. 5 is a block diagram of another turbocharged intercooled engine according to the present invention;

FIG. 6 is a block diagram of another turbocharged intercooled engine according to the present invention;

FIG. 7 is a block diagram of another turbocharged intercooled engine according to the present invention;

FIG. 8 is a block diagram of another turbocharged intercooled engine according to the present invention; and

FIG. 9 is a block diagram of another turbocharged intercooled engine according to the present invention.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted to keep the subject matter of the present invention clear.

The present invention provides a turbocharged-intercooled engine utilizing the turbo-cool principle and method for operating the same. A turbocharged intercooled engine according to the present invention operates according to the turbo-cool principle. The engine has an air turbine for turbo-expansion cooling. The air turbine is coupled to a compressor so intake air pressure loss as a result of turbo-expansion is partially compensated by pressure gain due to the compression process. This use of an air turbine and its coupling to a compressor define the essence of the turbo-cool principle.

A better understanding of the method can be obtained by analyzing the meaning of the turbo-cool principle: “cool” represents the cooling effect provided by the invention for conditioning of intake air temperature, and “turbo” represents the means provided by the invention to produce both load and speed control through turbo-compression in a compressor and conditioning of intake air temperature through turbo-expansion cooling of intake air in an air turbine. A single turbocharging process, driven by an exhaust gas turbine, produces load-and-speed control and conditioning of intake air temperature by turbo-compression in a compressor and turbo-expansion in an air turbine respectively.

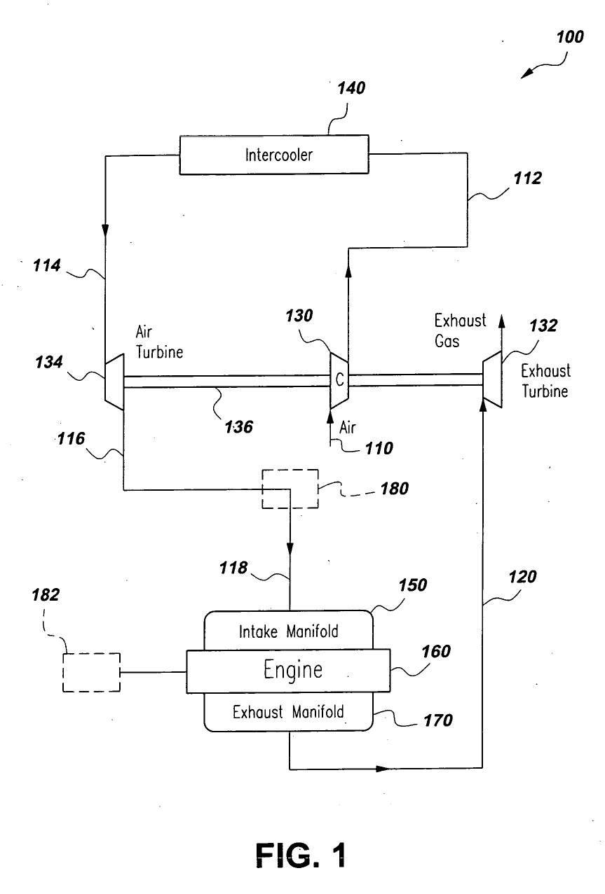

A turbocharged intercooled engine 100 in accordance with the present invention is shown in FIG. 1. Engine 100 operates according to a turbo-cooling process that uses exhaust-gas expansion in a turbine to achieve a higher effective expansion ratio in a straightforward manner. Excess power from higher exhaust-gas expansion through a turbine is used for conditioning intake charge-air for the purpose of engine-loss reduction. Engine 100 may be a homogenous charge spark ignition (SI) type, a heterogeneous charge compression ignition (diesel) type, a heterogeneous charge (direct-injection) spark ignition type, or a homogeneous charge compression ignition (HCCI) type.

Engine 100 includes a turbocharger, an intercooler 140, and one or more engine cylinders 160. The turbocharger includes a compressor 130, an exhaust turbine 132 and an air turbine 134 that can all be driven on single shaft 136. Exhaust turbines 132 and air turbine 134 may each be configured as a fixed geometry turbine or a Variable Geometry Turbine (VGT). A VGT turbine may include, for example, pivoting guide vanes to vary nozzle opening area, an axially sliding guide vane to vary nozzle opening area, or an external diaphragm-type actuator operated flow valve to distribute exhaust gas between an inner section and an outer section of an impellor housing. The air turbine 134 can be the only VGT turbine to achieve a broad range of charge-air temperatures. Alternatively, the exhaust turbine 132 and air turbine 134 can both be VGT turbines, where the exhaust turbine 132 can reduce turbo-lag. In addition, the exhaust turbine 132 can be the only VGT turbine when a fixed-geometry air turbine is sufficient for maintaining charge-air temperature.

An ambient air stream 110 enters compressor 130 of the turbocharger and exits as turbo-compressed air stream 112. Air stream 112 flows to intercooler 140, a heat exchanger, is cooled by an ambient coolant, and exits as turbo-compressed and intercooled air stream 114. Air stream 114 undergoes a turbo-expansion cooling process in air turbine 134, and exits air turbine 134 as air stream 116.

Air stream 116 is in communication with an engine charging system. For an SI engine, air stream 116 passes through a throttle butterfly 180 and enters the intake manifold 150 of engine cylinder 160 as charge-air stream 118 at charge-air pressure and charge-air temperature, P_{C} and T_{C.}

For a diesel engine, there is no throttle butterfly, and air stream 116 directly enters the intake manifold 150 of the engine cylinder 160 as charge-air stream 118.

Exhaust gas 120 exits exhaust manifold 170 of engine cylinder 160 and enters exhaust turbine 132 of turbocharger. Exhaust turbine 132 powers, or drives, the compressor 130.

Fuel is provided to the engine 160 using a fuel injection device 182. The fuel injection device 182 can be located at the intake manifold 150 for port injection for SI engines. For diesel engines, the fuel injection device 182 can be located at the engine cylinder 160. For a direct injection SI engine, two fuel injection devices 182 can be used. One fuel injection device 182 can be located at the engine cylinder 160 and the other fuel injection device 82 can be located at the intake manifold 150, the former being used during heterogeneous-charge mode and the latter during homogeneous-charge mode operation.

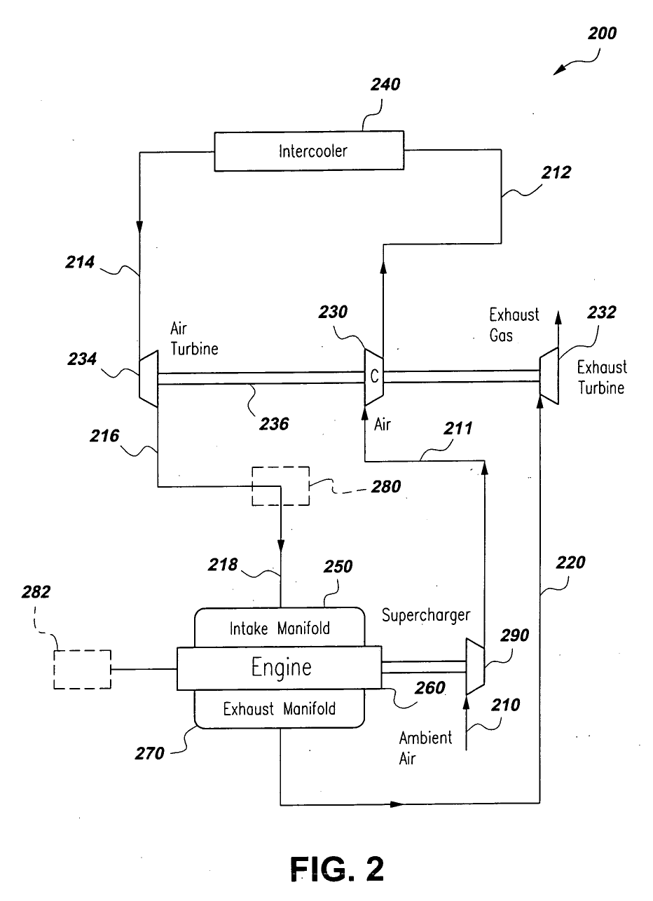

Another turbocharged intercooled engine 200 according to the present invention is shown in FIG. 2. Engine 200 is similar to engine 100 shown in FIG. 1, and additionally includes a supercharger 290. Supercharger 290 raises intake charge air pressure for maintaining high volumetric efficiency. An ambient air stream 210 enters supercharger 290 which raises the air pressure and outputs air stream 211. The operation of the rest of engine 200 is similar to engine 100 shown in FIG. 1.

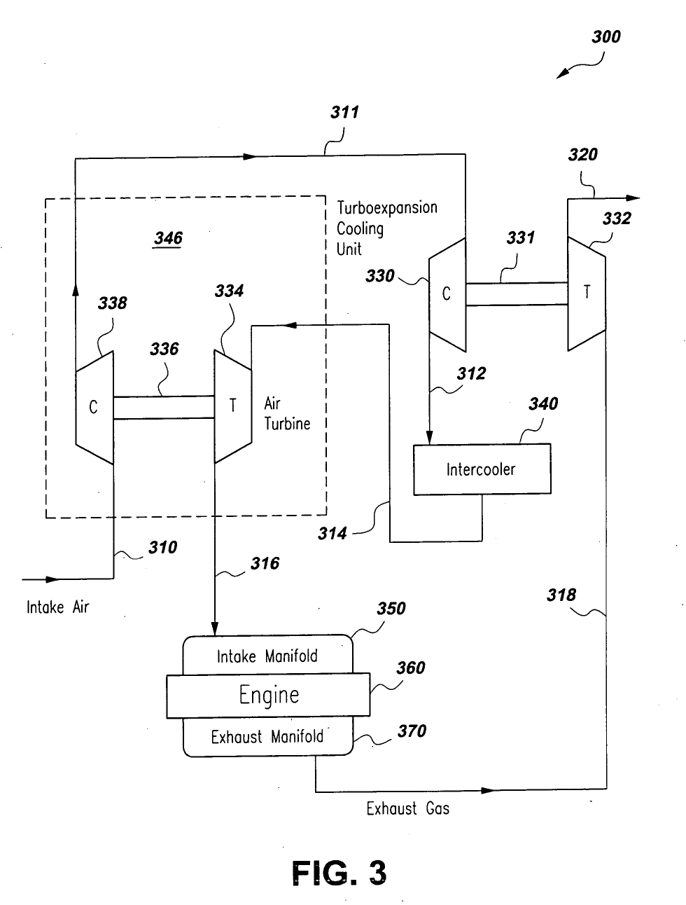

Another turbocharged intercooled engine 300 according to the present invention is shown in FIG. 3. The engine 300 includes a turboexpansion cooling unit 346, a turbocharger, an intercooler 340, and one or more engine cylinders 360. The turboexpansion cooling unit 346 includes an air turbine 334 and a compressor 338 along a shaft 336. The turbocharger includes a compressor 330 and an exhaust turbine 332 along a shaft 331. Exhaust turbine 332 and air turbine 334 may each be configured as a fixed geometry turbine or a VGT turbine. The air turbine 334 can be the only VGT turbine to achieve a broad range of charge-air temperatures. Alternatively, the exhaust turbine 332 and air turbine 334 can both be VGT turbines, where the exhaust turbine 332 can reduce turbo-lag. In addition, the exhaust turbine 332 can be the only VGT turbine when a fixed-geometry air turbine is sufficient for maintaining charge-air temperature.

An ambient air stream 310 enters compressor 338 of the turboexpansion cooling unit 346 and exits as turbo-compressed air stream 311. Air stream 311 flows to compressor 330 and exits as turbo-compressed air stream 312. Air stream 312 flows to intercooler 340, is cooled by an ambient coolant, and exits as turbo-compressed and intercooled air stream 314. Air stream 314 undergoes a turbo-expansion cooling process in air turbine 334, exits air turbine 334, and passes through an engine charging system as air stream 316.

Air stream 316 enters the intake-manifold 350 of engine cylinder 360 as charge-air stream 316.

Exhaust gas 320 exits exhaust manifold 370 of engine cylinder 360 and enters exhaust turbine 332 of the turbocharger. Exhaust turbine 332 powers, or drives, the compressor 330.

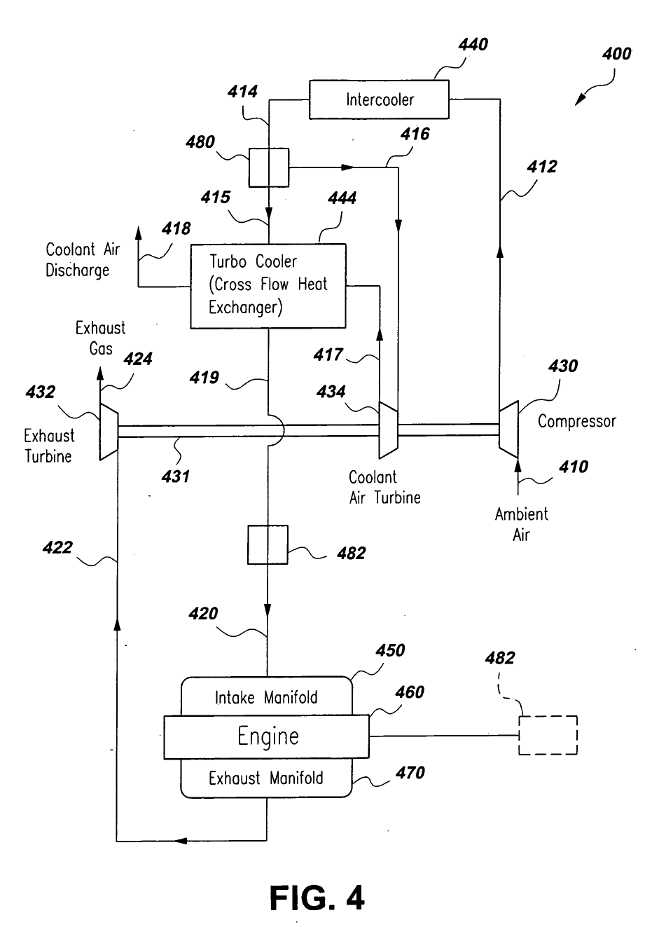

Another turbocharged intercooled engine 400 according to the present invention is shown in FIG. 4. The engine 400 includes a turbocharger, a turbo cooler 444, an intercooler 440, and one or more engine cylinders 460. The turbocharger includes a compressor 430, an exhaust turbine 432 and an air turbine 434 that can all be driven on single shaft 431. Exhaust turbine 432 and air turbine 434 may each be configured as a fixed geometry turbine or a VGT turbine. The compressor 430 and the intercooler 440 process turbo-compressed and intercooled airflow in excess of required charge airflow. Engine 400 may be referred to as a turbo-cool with excess compressed air engine.

An ambient air stream 410 enters compressor 430 of the turbocharger and exits as turbo-compressed air stream 412. Air stream 412 flows to intercooler 440, is cooled by an ambient coolant, and exits as turbo-compressed and intercooled air stream 414. Air stream 414 is divided with a turbo-cooler valve 480 into two paths. The air stream 415 of the first path is charge air for engine operation, and the air stream 416 of the second path is a coolant air stream.

Compressor 430 may be a variable geometry type of compressor enabling the handling of a large amount of turbo-compressed and intercooled airflow, e.g. charge airflow and excess compressed airflow, by compressor 430. Air stream 415 is conveyed to turbo cooler 444. The coolant air stream 416 undergoes a turbo-expansion cooling process in air turbine 434 and exits as coolant air stream 417. Coolant air stream 417 is conveyed to turbo cooler 444. The turbo cooler 444 may be a cross flow heat exchanger or a rotary heat exchanger. For a rotary heat exchanger, a rotating matrix of the heat exchanger is alternatively in contact with warmer air stream 415 and colder air stream 417. A coolant airstream 418 discharges into the atmosphere from turbo cooler 444. Air stream 419 exits turbo cooler 444 and passes through an engine charge system to become air stream 420 that enters intake manifold 450.

Exhaust gas 422 exits exhaust manifold 470 of engine cylinder 460 and enters exhaust turbine 432 of the turbocharger. Turbine 432 powers, or drives, the compressor 430. Exhaust gas 424 enters the atmosphere after exiting turbine 432. The other processes of engine 400 are similar to engine 100 shown in FIG. 1.

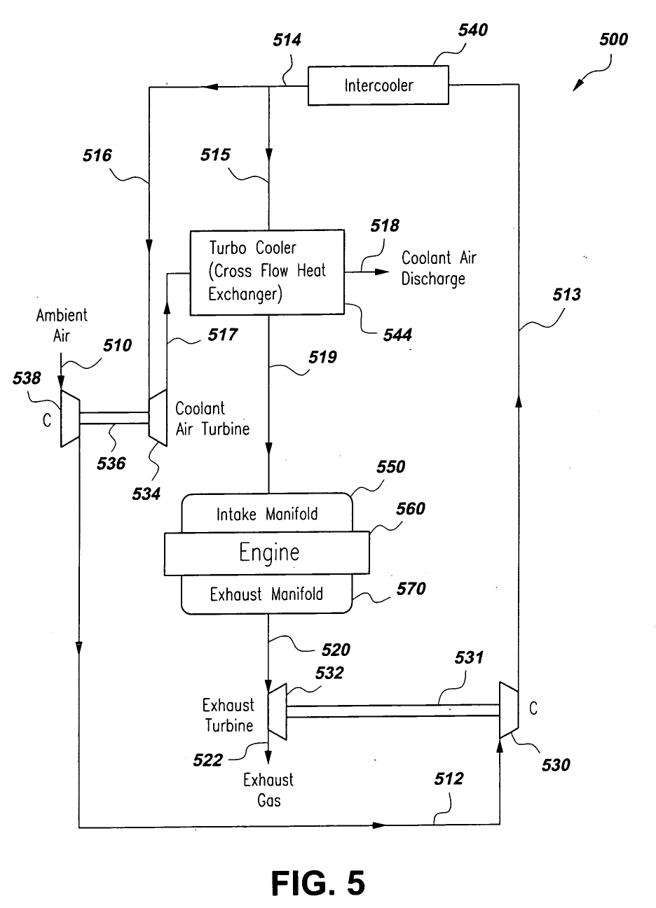

Another turbocharged intercooled engine 500 according to the present invention is shown in FIG. 5. The engine 500 is similar to engine 400 shown in FIG. 4. In engine 500, an ambient air stream 510 is compressed in compressor 538, which is powered by air turbine 534. Air stream 512 exits compressor 538 and enters compressor 530, where it is compressed and becomes air stream 513. Air stream 513 passes through intercooler 540 to become turbo-compressed and intercooled air stream 514.

Air stream 514 is divided into two paths. The air stream 515 of the first path is charge air for engine operation, and the air stream 516 of the second path is a coolant air stream. Air stream 515 is conveyed to the turbo cooler 544. Air stream 516 is in communication with an inlet of air turbine 534, where it undergoes a turbo-expansion cooling process and exits air turbine 534 as coolant air stream 517. Turbine 534 powers compressor 538. Air stream of the first path exits the turbo cooler and passes through an engine charging system to become charge air stream 519 that enters intake manifold 550. The other operations of engine 500 are similar to engine 400.

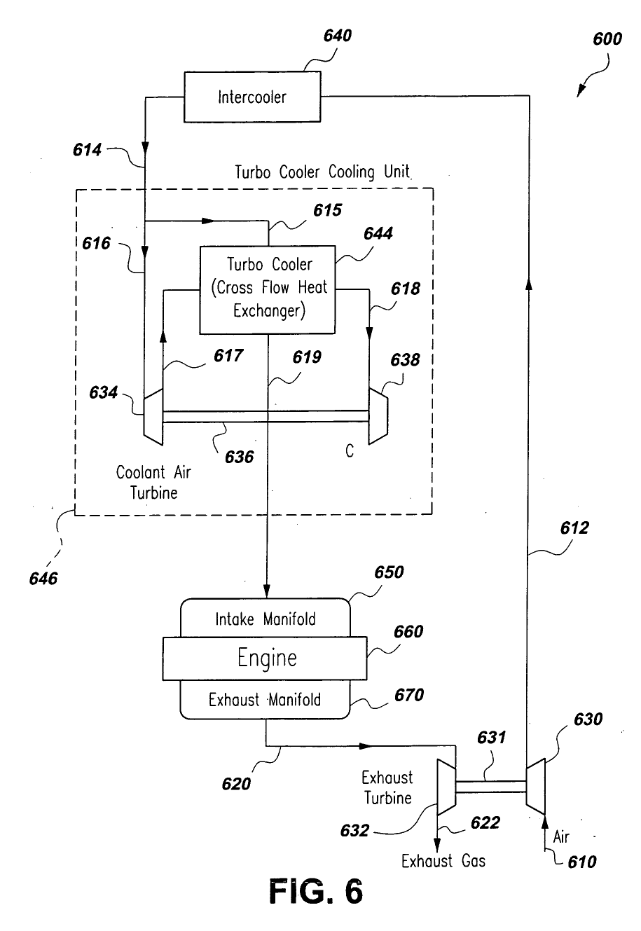

Another turbocharged intercooled engine 600 according to the present invention is shown in FIG. 6. Engine 600 includes a turbocharger, an intercooler 640, a turbo cooler cooling unit 646, and one or more engine cylinders 660. The turbocharger includes a compressor 630 and an exhaust turbine 632 along a shaft 631. Exhaust turbine 632 may be configured as a fixed geometry turbine or a VGT turbine. The compressor 630 and the intercooler 640 process turbo-compressed and intercooled airflow in excess of required charge airflow. Engine 600 may be referred to as a turbo-cool with excess compressed air engine.

An ambient air stream 610 enters compressor 630 of the turbocharger and exits as turbo-compressed air stream 612. Air stream 612 flows to intercooler 640, is cooled by an ambient coolant, and exits as turbo-compressed and intercooled air stream 614.

Air stream 614 is divided into two paths. The air stream 615 of the first path is charge air for engine operation, and the air stream 616 of the second path is a coolant air stream. Air stream 615 is conveyed to the turbo cooler 644. Air stream 616 is in communication with an inlet of coolant air turbine 634, where it undergoes a turbo-expansion cooling process. Coolant air turbine 634 powers compressor 638. Air stream 619 exits the turbo cooler 644 and passes through an engine charging system to become charge air stream that enters intake manifold 650. The other operations of engine 600 are similar to engine 500.

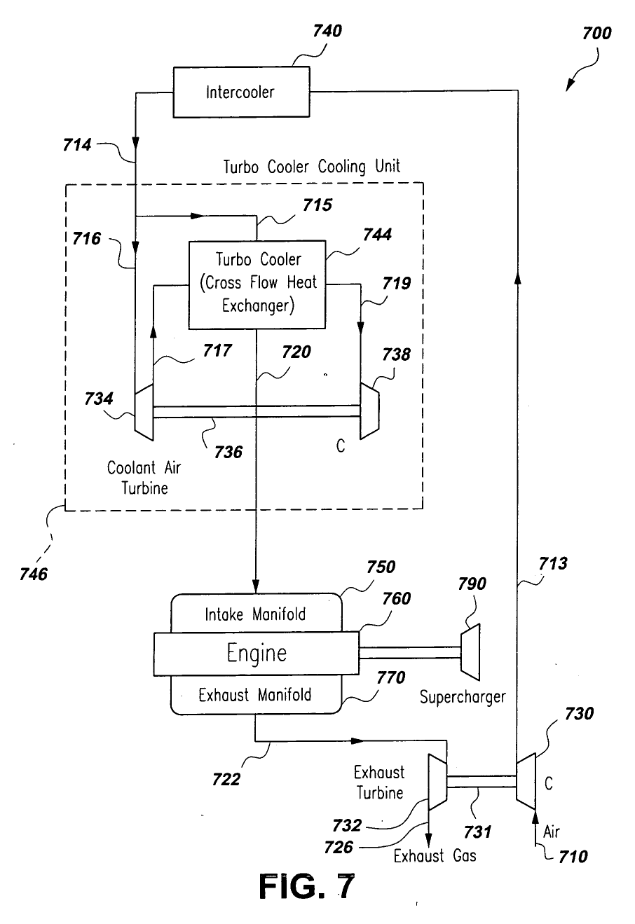

Another turbocharged intercooled engine 700 according to the present invention is shown in FIG. 7. Engine 700 is similar to engine 600 shown in FIG. 6, and additionally includes a supercharger 790. Supercharger 790 raises intake charge air pressure for maintaining high volumetric efficiency. An ambient air stream 710 enters compressor 730 of the turbocharger and exits as turbo-compressed air stream 712. Turbo-compressed air stream 712 enters supercharger 790 which raises the air pressure and outputs air stream 713. The operation of the rest of engine 700 is similar to engine 600 shown in FIG. 6.

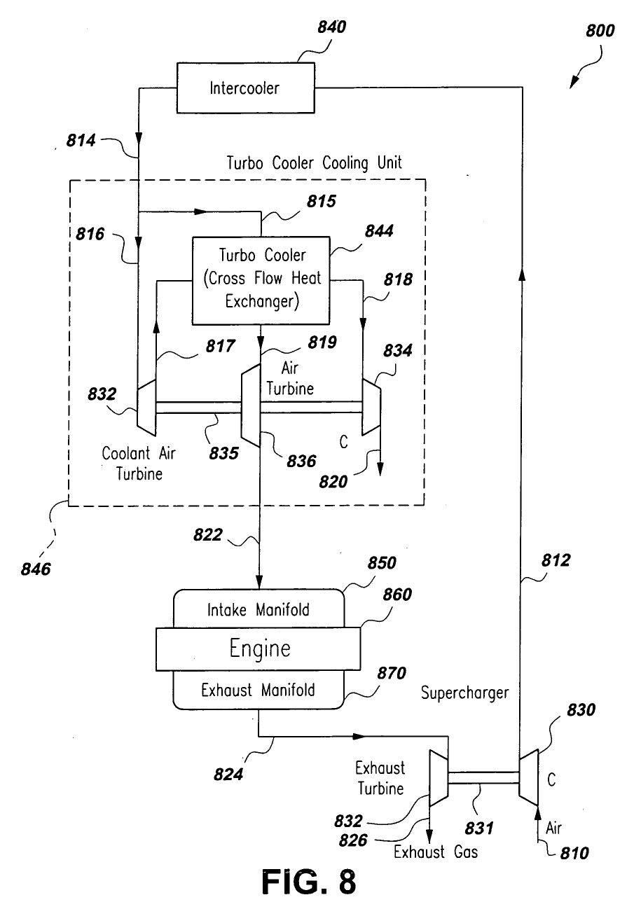

Another turbocharged intercooled engine 800 according to the present invention is shown in FIG. 8. Engine 800 includes a turbocharger, an intercooler 840, a turbo cooler cooling unit 846, and one or more engine cylinders 860. The turbocharger includes a compressor 830 and an exhaust turbine 832. Turbine 832 may be configured as a fixed geometry turbine or a VGT turbine. The compressor 830 and the intercooler 840 process turbo-compressed and intercooled airflow in excess of required charge airflow. Engine 800 may be referred to as a turbo-cool with excess compressed air engine.

An ambient air stream 810 enters compressor 830 of the turbocharger and exits as turbo-compressed air stream 812. Air stream 812 flows to intercooler 840, is cooled by an ambient coolant, and exits as turbo-compressed and intercooled air stream 814.

Air stream 814 is divided into two paths. The charge air stream 815 of the first path is charge air for engine operation, and the air stream 816 of the second path is a coolant air stream. Air stream 815 is conveyed to the turbo cooler. Air stream 816 is in communication with an inlet of coolant air turbine 832, where it undergoes a turbo-expansion cooling process. Coolant air turbine 832 powers compressor 834. Air stream 820 discharged from compressor 834 enters the atmosphere. Air stream 819 exits the turbo cooler 844 and passes through an inlet of air turbine 836, where it undergoes a turbo-expansion cooling process. A charge air stream exits air turbine 836 and passes through an engine charge system to become charge air stream 822 entering intake manifold 850.

Exhaust gas 824 exits exhaust manifold 870 of engine cylinder 860 and enters exhaust turbine 832 of the turbocharger. Exhaust turbine 832 powers, or drives, the compressor 830. Exhaust gas 826 enters the atmosphere after exiting turbine 832.

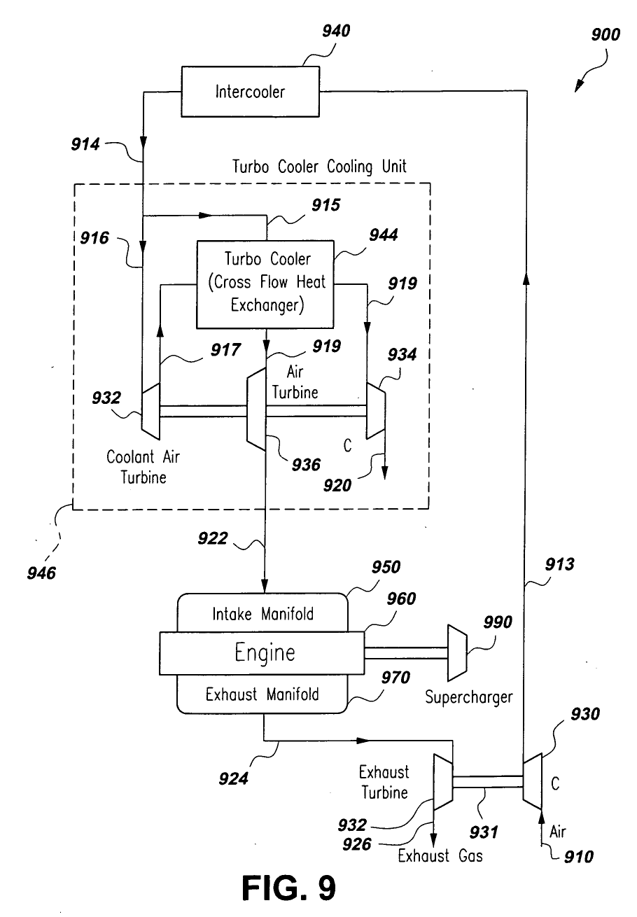

Another turbocharged intercooled engine 900 according to the present invention is shown in FIG. 9. Engine 900 is similar to engine 800 shown in FIG. 8, and additionally includes a supercharger 990. Supercharger 990 raises intake charge air pressure for maintaining high volumetric efficiency. An ambient air stream 910 enters compressor 930 of the turbocharger and exits as turbo-compressed air stream 912. Turbo-compressed air stream 912 enters supercharger 990 which raises the air pressure and outputs air stream 913. The operation of the rest of engine 900 is similar to engine 800 shown in FIG. 8.

An engine control module may be provided to an engine according to the present invention. Such an engine control module, which may be part of a power-train controller, receives input signals from various sensors including, for example, an ambient air sensor, an intake manifold pressure sensor, an exhaust charge temperature and oxygen sensor, throttle position sensor, fuel injection sensor, engine knock sensor (engine cylinder pressure sensor for diesel engines), engine speed sensor, driver command signals, etc. The control module generates command signals based on these input signals according to optimum settings. The command signals are sent to various components including, for example, a throttle butterfly switch (in the case of throttle-by-wire that a driver command does not directly control throttle butterfly position), a fuel injection actuator, an engine valve timing and lift control (may be a continuously variable intake valve in timing and lift), a turbo-cooler valve actuator, an electronic spark timing element, a nozzle opening for an exhaust turbine, a nozzle opening for an air turbine, a geometry control for a compressor, etc.

The above described engines include a turbocharger with an exhaust turbine, a compressor, and an air turbine which differs from turbochargers of the prior art which typically include an exhaust turbine and a compressor. The present invention also differs from the prior art because there is an absence of a wastegate. The present invention eliminates or minimizes the use of the wasteful practice of wastegate-bypassing of exhaust gas by charge-air cooling, and the use of a VGT turbocharger both for achieving cooling and for engine operation control. The present invention provides a substantial improvement over conventional turbocharged engines, and provides a vehicle powerplant that brings about outstanding drivability and acceleration, fuel economy (because of engine operation at low speeds near the operation “sweet spot”, light weight, and high compression ratio), and reliability (because of low engine speed operation).

While the invention has been shown and described with reference to certain preferred embodiments thereof, it will be understood by those skilled in the art that various changes in form and details may be made therein without departing from the spirit and scope of the invention as defined in the appended claims.

What is claimed is:

1. A turbocharger comprising an exhaust turbine, a compressor, and an air turbine on a single axle.

2. The turbocharger according to claim 1, wherein intake air pressure loss as a result of turbo-expansion is partially compensated by pressure gain due to a compression process in the compressor.

3. The turbocharger according to claim 1, wherein the exhaust turbine is a variable geometry turbine type of turbine.

4. The turbocharger according to claim 1, wherein the compressor is a variable geometry type of compressor.

5. The turbocharger according to claim 1, wherein the air turbine is a variable geometry turbine type of turbine.

6. The turbocharger according to claim 1, further comprising a supercharger.

7. A turbocharged intercooled internal combustion engine comprising:
a turbocharging system with an exhaust turbine, a compressor, and an air turbine;
a first operation control unit for load and speed control;
a second operation control unit for conditioning intake air temperature; and
an operation control for controlling start-of combustion,
wherein the first operation control unit and the second operation control unit simultaneously control load-and-speed and conditioning of intake air temperature.

8. The engine according to claim 7, wherein the exhaust turbine is a variable geometry turbine type of turbine.

9. The engine according to claim 7, wherein the compressor is a variable geometry type of compressor.

10. The engine according to claim 7, wherein the air turbine is a variable geometry turbine type of turbine.

11. The engine according to claim 7, wherein the air turbine drives a second compressor on a separate axle from the exhaust turbine axle.

12. The engine according to claim 7, wherein the second operation control unit comprises:
a turbo-cooler valve for distributing turbo-compressed and intercooled airflow into a charge-airflow and a coolant airflow, wherein the air turbine is for expanding and cooling the coolant airflow; and
a heat transfer unit where the expanded and cooled coolant airflow absorbs heat from the charge-airflow.

13. The engine according to claim 12, wherein the air turbine drives a second compressor on a separate axle from the exhaust turbine axle.

14. The engine according to claim 7, wherein the air turbine drives a suction-compressor on a separate axle from the exhaust turbine axle, and the suction-compressor compresses the coolant airflow exiting from the heat transfer unit to ambient pressure and discharges the coolant airflow.

15. The engine according to in claim 7, wherein the internal combustion engine is a homogeneous charge spark ignition engine, and wherein:
the first operation control unit includes a throttle butterfly and a geometry-control of the exhaust turbine;
the start-of-combustion is controlled by a spark plug; and
the conditioning of intake air temperature improves thermal efficiency and avoids knock.

16. The engine according to claim 7, wherein the internal combustion engine is a diesel (heterogeneous charge compression ignition) engine, and wherein:
the first operation control unit includes a fuel injection system and a geometry-control of the exhaust turbine;
the start-of-combustion is controlled by the fuel injection timing; and
the conditioning of intake air temperature improves thermal efficiency and reduces thermal loading at high engine loads.

17. The engine according to claim 7, wherein the internal combustion engine is a homogeneous charge compression ignition (HCCI) engine, and wherein:
the first operation control unit includes a fuel injection system, a throttle butterfly and a geometry-control of the exhaust turbine; and
the start-of-combustion is controlled to promote ignition at low loads, and the second operation control unit prevents premature ignition at high engine loads.

18. The method according to claim 7, further comprising providing the exhaust turbine, compressor, and air turbine on a single axle.

19. The engine according to claim 7, further comprising a supercharger.

20. A turbocharging method comprising:
providing a turbocharger including an exhaust turbine, a compressor, and an air turbine; and
simultaneously controlling load-and-speed and conditioning of intake air temperature.

21. The method according to claim 20, wherein the conditioning of intake air temperature step is performed by a cooling effect of turbo-expansion of turbo-compressed and intercooled air through an air turbine.

22. The method according to claim 20, further comprising providing the exhaust turbine as a variable-geometry-turbine type of turbine.

23. The method according to claim 20, further comprising providing the compressor as a variable geometry type of compressor.

24. The method according to claim 20, further comprising providing the air turbine as a variable geometry turbine type of turbine.

25. The method according to claim 20, further comprising:
providing the turbocharger in a turbocharged intercooled internal combustion engine; and
performing the conditioning of intake air temperature step by extracting heat by a coolant airflow from a charge-airflow, the coolant airflow being produced by a cooling effect of turbo-expansion of excess compressed air through the air turbine.

26. The method according to claim 20, further comprising providing the turbocharger in a homogeneous charge spark ignition internal combustion engine.

27. The method according to claim 26, wherein the controlling of load-and-speed step is performed by a throttle butterfly and geometry-control of the exhaust turbine.

28. The method according to claim 27, further comprising:
establishing a function for achieving optimal thermal efficiency at a given intake air pressure; and
setting a nozzle opening of the exhaust turbine as a function of a throttle butterfly setting, an intake air pressure, an engine speed, an ambient temperature, a pressure, and a humidity.

29. The method according to claim 20, further comprising providing the turbocharger in a diesel (heterogeneous charge compression ignition) engine.

30. The method according to claim 29, wherein the controlling of load-and-speed step is performed by fuel-rate control and geometry-control of the exhaust turbine.

31. The method according to claim 30, further comprising:
establishing a function for achieving optimal thermal efficiency at a given intake air pressure; and
setting a nozzle opening of the exhaust turbine as a function of a fuel rate control setting, an intake air pressure, an engine speed, an ambient temperature, a pressure, a humidity.

32. The method according to claim 20, further comprising providing the turbocharger in a direct-injection spark ignition engine.

33. The method according to claim 20, further comprising providing the turbocharger in a homogeneous charge compression ignition (HCCI) engine.

34. The method according to claim 20, further comprising:
providing the compressor as a variable-geometry type compressor; and
performing turbo-compression by the compressor.

34. The method according to claim 20, further comprising performing geometry control of the air turbine to condition intake air temperature.

35. The method according to claim 33, wherein the controlling of load and speed step is performed by a throttle butterfly, fuel-rate control, or geometry control of the exhaust turbine, and the controlling of the start-of-combustion step is assisted by geometry control of the air turbine.

36. The method according to claim 35, further comprising:
establishing a function for conditioning intake air temperature at a given intake air pressure to produce start-of-combustion at a crank angle resulting in maximum torque; and
setting a nozzle opening of the exhaust turbine and a nozzle opening of the air turbine according to the established function.

37. The method according to claim 20, further comprising providing the exhaust turbine, compressor, and air turbine on a single axle.

38. The method according to claim 20, further comprising providing a supercharger.

39. An engine management method comprising:
providing a turbocharger including an exhaust turbine, a compressor, and an air turbine;
sensing engine management data; and
generating outputs based on the sensed data.

40. The method according to claim 39, wherein the sensing engine management data step further comprises:
sensing data including a load requirement signal, an intake manifold pressure, an engine speed, a knock sensor signal for a homogeneous charge spark ignition engine, a fuel air ratio, a temperature sensor signal, an ambient condition, and a crank angle at start-of-combustion.

41. The method according to claim 39, wherein the generating outputs step further comprises:
generating a signal for a servo element for controlling a nozzle opening of the exhaust turbine.

42. The method according to claim 39, wherein the generating outputs step further comprises:
generating a signal for a servo element for controlling a nozzle opening of the air turbine.

43. The method according to claim 39, wherein the generating outputs step further comprises:
generating a signal for a servo element for controlling a geometry-setting of the compressor.

44. The method according to claim 39, further comprising wherein the generating outputs step further comprises:
selecting an output for conditioning intake air to improve thermal efficiency and avoid knock in application to homogeneous charge spark ignition engines.

45. The method according to claim 39, wherein the generating outputs step further comprises:
selecting an output for improving thermal efficiency and reducing thermal loadings at high engine loads in application to heterogeneous charge compression ignition engines leading to improved rated power.

46. The method according to claim 39, wherein the generating outputs step further comprises:
selecting an output for improving thermal efficiency and producing start-of-combustion at a crank-angle at middle and high engine loads resulting in maximum brake torque in application to homogeneous charge compression ignition engines.

47. The method according to claim 39, further comprising providing the exhaust turbine, compressor, and air turbine on a single axle.

48. The method according to claim 39, further comprising providing a supercharger.
